(19) United States
(12) Patent Application Publication
(10) Pub. No.: US 2006/0095725 A1
(43) Pub. Date: May 4, 2006

(54) Method and apparatus for executing instructions from an auxiliary data stream

(76) Inventor: Woodrow L. Meeker, Orlando, FL (US)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(21) Appl. No.: 11/203,479

(22) Filed: Aug. 12, 2005

Related U.S. Application Data
(60) Provisional application No. 60/605,911, filed on Aug. 31, 2004.

(51) Int. Cl. G06F 9/40

(52) U.S. Cl. 712/205

(57) ABSTRACT

System and method for the execution of instructions from an auxiliary data stream in a parallel processing system are presented. The data processing system includes a program sequencer, an array processor and data input/output logic. Rather than increasing the program memory size to accommodate the most extreme application requirements, a method for executing from an auxiliary data stream via an “expansion interface” is provided. Specifically, program instructions are stored within and provided from the system's frame buffer. An additional data stream including program sequencer instructions is added to the memory controller capabilities. During execution from the expansion interface, the sequencing logic of the program sequencer receives and executes instructions from this auxiliary data stream in lieu of execution from the program memory.

### CROSS-REFERENCE TO RELATED APPLICATIONS

This application claims the benefit of U.S. Provisional Application Ser. No. 60/605,911 filed Aug. 31, 2004, the disclosure of which is hereby incorporated by reference herein in its entirety, and commonly owned.

### FIELD OF THE INVENTION

This invention relates to SIMD parallel processing, and in particular, to executing instructions from an auxiliary data stream.

### BACKGROUND OF THE INVENTION

Parallel processing architectures, employing the highest degrees of parallelism, are those following the Single Instruction Multiple Data (SIMD) approach and employing the simplest feasible Processing Element (PE) structure: a single-bit arithmetic processor. While each PE has very low processing throughput, the simplicity of the PE logic supports the construction of processor arrays with a very large number of PEs. Very high processing throughput is achieved by the combination of such a large number of PEs into SIMD processor arrays.

A variant of the bit-serial SIMD architecture is one for which the PEs are connected as a 2-D mesh, with each PE communicating with its 4 neighbors to the immediate north, south, east and west in the array. This 2-d structure is well suited, though not limited to, processing of data that has a 2-d structure, such as image pixel data.

### SUMMARY OF THE INVENTION

One embodiment of the present invention provides a digital data processing system that may comprise a program sequencer having a program memory adapted to store program instructions, a program counter, coupled to said program memory, adapted to provide a program memory address, and an instruction decoder, coupled to said program memory, adapted to decode instructions received from the program memory; a data source, coupled to said program sequencer, and adapted to provide a sequential stream of program instructions; and an expansion interface, coupled to said program sequencer and said data source, and comprising receiving means adapted to receive program instructions from the data source, and further comprising first control means adapted to provide said program instructions to the instruction decoder in lieu of program instructions received from the program memory.

Further details and different aspects and advantages of embodiments of the invention are revealed in the following description along with the accompanying drawings.

### BRIEF DESCRIPTION OF THE DRAWINGS

Embodiments of the invention are described by way of example with reference to the accompanying drawings in which:

FIG. 1 is a schematic diagram showing the components of the SIMD array processor built in accordance with the present invention;

FIG. 2 is a schematic diagram showing the components and data paths of the array sequencer;

FIG. 3 is a schematic diagram showing the frame buffer and memory clients;

FIG. 4 is a schematic diagram of the expansion interface;

FIG. 5 is a table showing the format of instruction storage in the frame buffer; and

FIG. 6 is a graphical representation of expansion sequence execution, including a jump in sequence and calls to program memory routines.

### DETAILED DESCRIPTION OF THE PREFERRED EMBODIMENTS

The present invention will now be described more fully hereinafter with reference to the accompanying drawings, in which embodiments of the invention are shown, by way of example. The present invention relates to parallel processing of digital data, and in particular, digital image pixel data. This invention may, however, be embodied in many different forms and should not be construed as limited to the embodiments set forth herein. Rather, these embodiments are provided so that this disclosure will be thorough and complete, and will fully convey the scope of the invention to those skilled in the art. By way of example, although the embodiments disclosed herein relate to the particular case of image pixel data, it should be understood that pixel data could be replaced with any digital data without departing from the scope and spirit of this invention. Like numbers refer to like elements throughout.

An exemplary embodiment of the invention is part of a parallel processor used primarily for processing pixel data. The processor comprises a processing element (PE) array, sequence control logic, and pixel input/output logic. The architecture is single instruction multiple data (SIMD), wherein a single instruction stream controls execution by all of the PEs, and all PEs execute each instruction simultaneously. The array of PEs will be referred to as the SIMD array and the overall parallel processor as the SIMD array processor 2000.

The SIMD array described above provides the computation logic for performing operations on pixel data. To perform these operations, the SIMD array requires a source of instructions and support for moving pixel data in and out of the array.

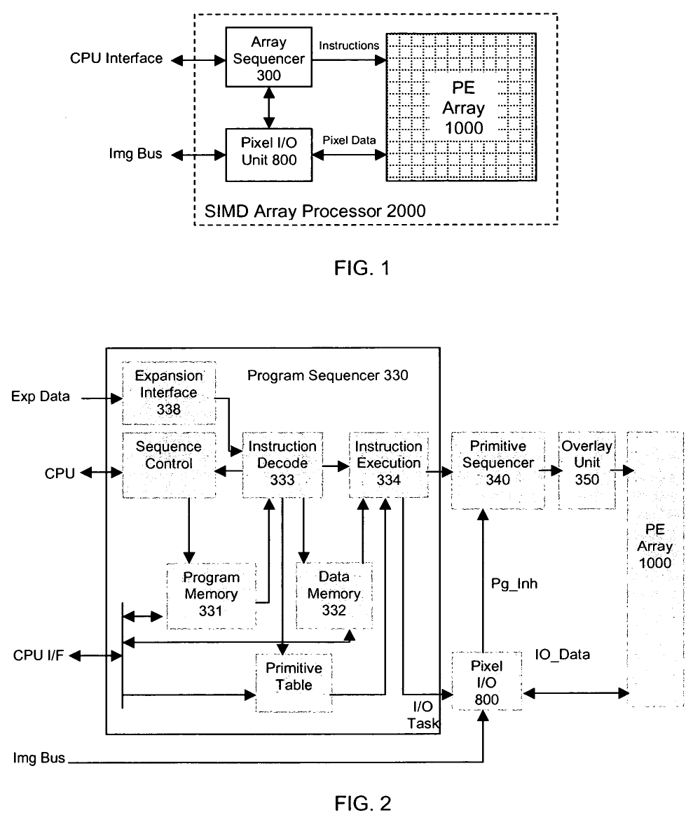

An exemplary SIMD array processor is shown in FIG. 1. SIMD array processor 2000 includes array sequencer 300 to provide the stream of instructions to the PE array 1000. Pixel I/O unit 800 is also provided for the purpose of controlling the movement of pixel data in and out of the PE array. Collectively, these units comprise a SIMD array processor 2000.

The SIMD array processor 2000 may be employed to perform algorithms on array-sized image segments. This processor might be implemented on an integrated circuit device or as part of a larger system on a single device. In either implementation, the SIMD array processor 2000 is subordinate to a system control processor, referred to herein as the “CPU”. An interface between the SIMD array processor 2000 and the CPU provides for initialization and control of the exemplary SIMD array processor 2000 by the CPU.

Pixel I/O unit 800 provides control for moving pixel data between the PE array 1000 and external storage via an image buss called “Img Bus”. The movement of pixel data is performed concurrently with PE array computations, thereby providing greater throughput for processing of pixel data. The pixel I/O unit 800 performs a conversion of image data between pixel form and bit plane form. Img Bus data is in pixel form and PE array data is in bit plane form, and the conversion of data between these forms is performed by the pixel I/O unit 800 as part of the I/O process.

The SIMD array processor 2000 processes image data in array-sized segments known as “subframes”. In a typical scenario, the image frame to be processed is much larger than the dimensions of the PE array. Processing of the image frame is accomplished by processing subframe image segments in turn until the image frame is fully processed.

In an exemplary embodiment employing the SIMD array processor 2000, a frame buffer memory provides storage for image data external to the SIMD array processor 2000. The frame buffer memory communicates with the SIMD array processor 2000 via the Img Bus interface. To meet bandwidth requirements, the width of the exemplary frame buffer memory and Img Bus interface is 64-bits in this particular embodiment.

Referring now to FIG. 2, the control of subframe processing in the PE array 1000 is provided by a hierarchical arrangement of sequencer units, referred to collectively as the array sequencer 300. These units include the program sequencer 330, which sequences the application and dispatches image operations (also known as “primitives”) to the primitive sequencer 340, the primitive sequencer 340, and the overlay unit 350. The output of the overlay unit 350 is a stream of PE instructions that provides control to the PE array 1000 for executing subframe operations.

The program sequencer 330 is the highest-level sequencer in the hierarchy and is the controlling sequencer for the SIMD array processor 2000. In one example of the present invention, program sequencer 330 employs a Harvard type architecture with separate program memory 331 and data memory 332. The program sequencer 330 is a minimal implementation of a serial processor, providing a basic set of sequencing and scalar processing capabilities. The purpose of the program sequencer 330 is to control program flow for algorithms that are executed primarily on the PE array 1000. To that end, a capability for building and dispatching “primitives”, i.e. PE array operations, and I/O tasks is well supported. Basic scalar arithmetic functions are included as well as a conventional data memory and register set. Branching capabilities are basic as well, including JMP, CALL and RET operations.

The CPU controls the SIMD array processor 2000 by communicating with and controlling the program sequencer 330. It achieves this through the “CPU Interface”, which includes mode controls (stall, etc.), status and control signals, and memory mapped access to program sequencer memories. To run a program, the CPU would stall the program sequencer 330, download a program to the program memory 331, download any necessary scalar data to data memory 332, and then restart program sequencer 330. After completion of the program, the CPU might stall program sequencer 330 and read back result data from data memory 332.

Program sequencer 330 executes instructions from program memory 331. Instructions are read from program memory 331 and loaded to the instruction decode register 333. The instruction in the instruction decode register 333 is decoded, and the decoded instruction is loaded to instruction execution register 334. From instruction execution register 334, the instruction is executed in program sequencer 330. If the instruction is an array operation, a primitive is dispatched to primitive sequencer 340. If the instruction is an I/O operation, an I/O task is dispatched to pixel I/O unit 800.

Program sequencer 330 builds and dispatches subframe I/O tasks to pixel I/O unit 800. An I/O task specifies the movement of a subframe image between frame buffer 900 and PE array 1000. The subframe I/O task executes concurrently with any ongoing PE array operations. Upon completion of a dispatched I/O task, a condition called IO_Done is returned from pixel I/O unit 800 to provide a rendezvous between the program sequencer 330 and pixel I/O unit 800.

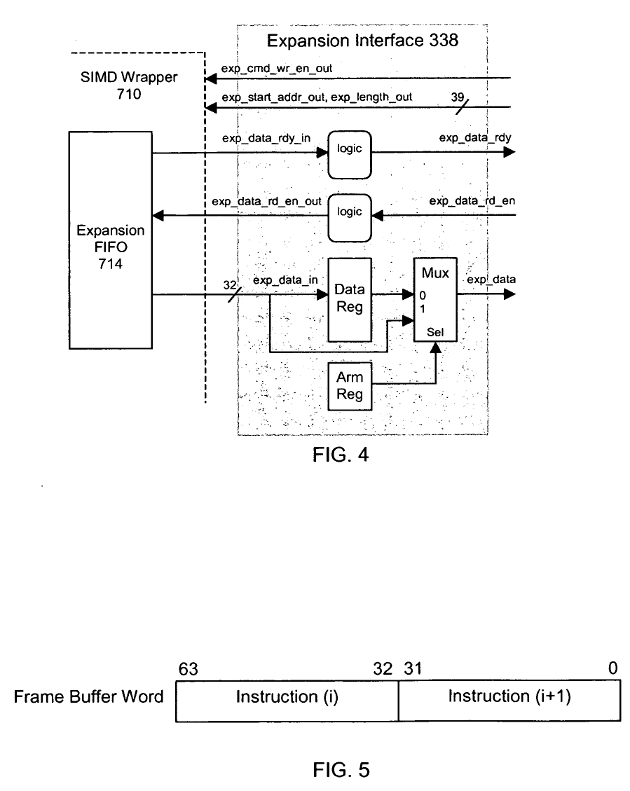

In an exemplary embodiment, the program memory size is 8 k deep by 32 bits. This memory size is carefully chosen to support execution of a set of target applications. The 8 k depth is sufficient for most, though not all identified applications. One reason a deeper memory is not used is to keep the die space requirement of the SIMD array processor 2000 to a minimum. Moreover, whatever memory size is selected, it is conceivable that an application might be identified for which that memory is insufficient. To avoid the situation where the program memory depth limitation would make implementation of an application impossible, a method for effectively expanding the program memory is presented in this invention. This method uses frame buffer 900 to provide a stream of program sequencer instructions via expansion interface 338, shown in FIG. 4, to program sequencer 330.

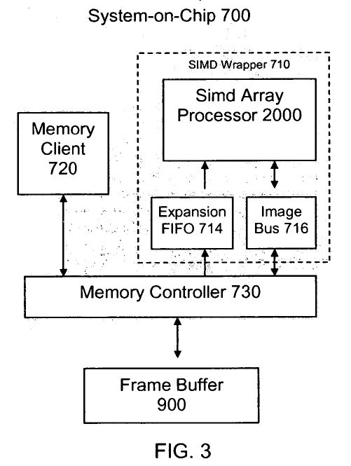

Referring now to FIG. 3, in one exemplary embodiment, the SIMD array processor 2000 is one of several components included on an integrated circuit device called system-on-chip 700. Frame buffer 900 is accessed by other components, namely memory client 720, in addition to the image bus 716 interface of the SIMD wrapper 710. Memory controller 730 handles the sharing of frame buffer 900 by the multiple components, several of which may have I/O tasks pending at any given moment.

The following glossary is used in the rest of this disclosure to further explain detailed aspects of the present invention:

SIMD wrapper—logic surrounding the SIMD array processor that provides support for subframe I/O and expansion operations functioning as an interface layer between the SIMD array processor and outside units, such as the CPU and the memory controller

Wrapper—(in the context of the expansion interface) interface logic that provides registration of received data in order to meet timing constraints, providing the same handshake signals to both sides (i.e. expansion interface and expansion FIFO) as would be utilized in the absence of the wrapper

JMP—program sequencer instruction that performs a branch

CALL—program sequencer instruction that performs a branch while pushing a return address to the PC stack

RET—program sequencer instruction that performs a return from a CALL by popping a return address from the PC stack and branching to that address

EXP_ADDR—program sequencer instruction that loads an expansion address value to the Exp_Addr_reg

EXP_LEN—program sequencer instruction that dispatches an expansion command, providing the expansion length as part of the command

Exp_Addr_Reg—register that holds the expansion address

Data_Reg—register in the expansion interface that holds data received from the expansion FIFO

Arm_Reg—register in the expansion interface that indicates whether the Data_Reg holds valid data from the expansion FIFO that is not yet received by the program sequencer

Exp_data_in—input to the expansion interface conveying instruction data from the expansion FIFO

Exp_data_rdy_in—input to the expansion interface indicating that the Exp_Data_in is valid data that may be received by the expansion interface

Exp_data_rd_en_out—output from the expansion interface indicating that Exp_Data_in is being received by the expansion interface

Exp_data—output from the expansion interface conveying instruction data to the program sequencer

Exp_data_rdy—output from the expansion Interface indicating to the program sequencer that the Exp_Data is valid data that may be received by the program sequencer

Exp_data_rd_en—input to the expansion interface indicating that Exp_Data is being received by the program sequencer

To support execution from frame buffer 900, program sequencer 330 has an expansion interface 338 through which instruction data is received. The expansion interface 338 is capable of moving data in one direction only—from frame buffer 900 to the program sequencer 330. Expansion FIFO 714 is used to buffer instruction data as it is moved to the expansion interface 338. Expansion FIFO 714 is controlled by memory controller 730.

An expansion sequence is launched by performing an EXP_ADDR operation followed by an EXP_LEN operation in program sequencer 330. EXP_ADDR loads a frame buffer base address, the “expansion address”, to the Exp_Addr_Reg register of the program sequencer 330. EXP_LEN provides the “expansion length”, the length of the expansion sequence in frame buffer 900. Execution of the EXP_LEN operation causes the program sequencer 330 to send an expansion command to the memory controller signifying that an expansion transfer is to begin. The command includes the expansion address and expansion length information provided in the EXP_ADDR and EXP_LEN operations. (In one exemplary embodiment, both address and length parameters are in units of 32 bytes.)

The memory controller begins the process of moving the data to the expansion FIFO 714 in response to the expansion command. Once instruction data is received and written to the expansion FIFO 714, it is available for execution by the program sequencer 330. The transition of the program sequencer 330 to a mode of executing from expansion FIFO 714 occurs by branching to an address of 0×2000 or higher (up to 0×3fff). The addresses in the range 0×2000 and higher are beyond the address range of the program memory 331 in this exemplary embodiment.

During execution of the expansion sequence, the program counter (PC) will remain at 0×2000 until a branch out of that space is performed. As long as the PC is in the expansion range, instructions will be fetched from the expansion FIFO 714 instead of program memory 331. A CALL from within an expansion sequence to a program memory routine is supported. Once the PC leaves the 0×2000 space (due to the CALL), execution from expansion FIFO 714 ceases and execution from program memory 331 begins. A RET from the subroutine will put the PC back to 0×2000 and execution of the expansion sequence will resume.

The branch to the expansion sequence is preferably a CALL. This allows the expansion sequence to be terminated by a RET operation. It is critical that the expansion length value match the expansion code that is executed (i.e. the expansion code in frame buffer 900). If the expansion length is shorter than the expansion sequence (i.e. the expansion sequence does not include a RET), program sequencer 330 will hang up waiting for expansion instructions that will never arrive.

In this embodiment of the invention, the units for expansion length are 32-byte (i.e. 8 instructions) meaning that the total number of program sequencer instructions to be read from frame buffer 900 will be a multiple of 8. The final instruction of the expansion sequence (presumably a RET) might fall anywhere within the final group of 8 data words, meaning that there may be a small remnant of unused data in expansion FIFO 714. This situation is handled by abandoning the remnant in expansion FIFO 714. There is no adverse result for doing this since expansion FIFO 714 is cleared at the beginning of every expansion sequence, specifically in response to dispatch of the expansion command. In this manner, the data remnant is prevented from being prepended to a subsequent expansion sequence.

Referring now to FIG. 4, Expansion interface 338 provides a basic rd_rdy—rd_en handshake for movement of data from expansion FIFO 714 to program sequencer 330. In the interest of timing, a wrapper with a data holding register (Data_Reg) is included in the interface. An arm register (Arm_Reg) is active when the Data_Reg holds valid data. The value of Exp_data is generated by a mux based on the value of the Arm_Reg. When the Arm_Reg is inactive and Exp_data_rdy_in is true, Exp_data_rd_en_out is asserted. If either the Arm_Reg or Exp_data_rd_en_out are active, Exp_data_rdy is asserted.

If program sequencer 330 is ready for an instruction from the expansion interface 338 and Exp_Data_rdy is active, Exp_Data_rd_en is asserted and—within the same cycle—Exp_Data is read, providing the expansion instruction for execution.

The exemplary frame buffer has a 64-bit data width. Since program sequencer instructions are 32-bits in width, each frame buffer word comprises 2 program sequencer instructions, as shown in FIG. 5. A pair of instructions is stored such that the first instruction is in the upper (most significant) half of the data word and the second instruction of the pair is in the lower (least significant) half of the data word.

The execution of an expansion sequence begins with a two-step process. The first step is to dispatch the expansion “command” to the memory controller so that it may begin the process of moving the data block to expansion FIFO 714. As described above, the dispatch of this command is accomplished by executing the EXP_ADDR and EXP_LEN sequence of operations. Specifically, the EXP_LEN operation causes the dispatch of the expansion sequence command to the memory controller.

The second step is to put the program sequencer 330 in a mode of executing from the expansion interface 338. As mentioned before, the program sequencer 330 executes from the expansion interface 338 anytime the PC is in the range 0×2000 to 0×3fff. So, the execution of the expansion sequence by the program sequencer 330 begins after the program sequencer 330 branches to 0×2000 (or beyond). For all non-branching instructions in the expansion sequence, the PC is set to 0×2000, so that regardless of the original jump-in address, the remainder of the expansion sequence will execute with a PC value of 0×2000.

The expansion sequence may contain instructions that cause a branch out of the 0×2000 space. Preferably such a branch will be a CALL, causing the 0×2000 value to be pushed to the PC stack. At any rate, the branch out of the 0×2000 space causes execution from the program memory 331 to resume. Therefore, a CALL to a program memory routine from an expansion sequence is supported. Upon RET from the CALL, the PC will be set to 0×2000 and execution of the expansion sequence will continue from the point immediately following the CALL instruction.

The delay between dispatching the expansion command and receiving the first instructions in the expansion FIFO 714 may be significant. The expansion interface 338 is one of several clients being served by the memory controller, and it is likely that the latency from command dispatch to availability of instructions could be significant. To prevent the program sequencer 330 from being idle during this latency period, the programmer might choose to delay the jump to 0×2000 until the latency period has expired, thereby preventing any loss of execution time due to the latency.

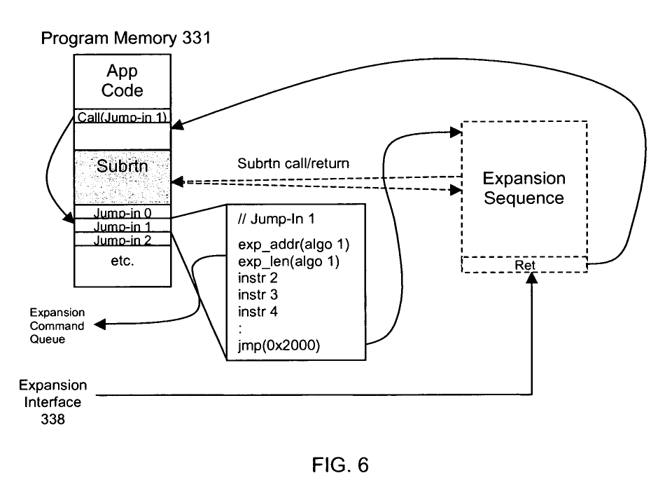

With this in mind, the programmer might choose to encapsulate the expansion sequence in a manner illustrated by FIG. 6. In this approach, the code sequence to be implemented via expansion interface 338 is modeled as a subroutine to be CALLed from the application code body. The application code body CALLs a “Jump-in” block of instructions that begins with the EXP_ADDR and EXP_LEN instructions that perform the dispatch of the expansion command. These instructions are followed by a sequence of 50 to 100 instructions representing the first 50 to 100 instructions of the code sequence. At the end of this sequence is a JMP to 0×2000. The 50 to 100 instructions provide useful processing during the latency period for loading the beginning of the expansion sequence to expansion FIFO 714. The expansion sequence from frame buffer 900 picks up where the 50 to 100-instruction sequence leaves off. The JMP to 0×2000 causes processing to continue with the expansion sequence via the expansion interface 338. The expansion sequence ends with a RET instruction, effectively performing a return from the original CALL back to the application code body. Also illustrated by FIG. 6 is the fact that the expansion sequence can make calls to program memory subroutines.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A digital data processing system comprising:
a program sequencer comprising:
a program memory adapted to store program instructions,
a program counter, coupled to said program memory, adapted to provide a program memory address, and
an instruction decoder, coupled to said program memory, adapted to decode instructions received from the program memory;
a data source, coupled to said program sequencer, and adapted to provide a sequential stream of program instructions; and
an expansion interface, coupled to said program sequencer and said data source, and comprising receiving means adapted to receive program instructions from the data source, and further comprising first control means adapted to provide said program instructions to the instruction decoder in lieu of program instructions received from the program memory.

2. The system of claim 1, wherein said data source is adapted to provide data to at least one client in addition to said program sequencer.

3. The system of claim 1, wherein said data source comprises a memory.

4. The system of claim 3, further comprising second control means adapted to specify an address in said memory wherein is located the first of the program instructions comprising said sequential stream.

5. The system of claim 1, wherein the expansion interface further comprises detecting means for detecting the condition wherein an expansion program instruction is not available for execution, and wherein the program sequencer is adapted to suspend execution in response to said condition.

6. The system of claim 1, further comprising third control means adapted to specify a number of instructions, wherein said data source is further adapted to provide a sequential stream comprising the specified number of instructions in response to said third control means value.

7. The system of claim 1, wherein said means for receiving a program instruction from the data source is a FIFO memory.

8. The system of claim 1, wherein said expansion interface first control means is adapted to select said program instruction, received from the data source in response to a program counter value that is within an expansion address range, said address range being designated for execution from the expansion interface.

9. The system of claim 8, further adapted to perform a branch, said Branch occurring in response to a program instruction received from the program memory, wherein said program instruction specifies a branch to said expansion address range, said branch causing execution from the expansion interface to begin.

10. The system of claim 8, further adapted to perform a branch, said branch occurring in response to a program instruction received from the expansion interface, wherein said program instruction specifies a branch to an address within the range of program memory addresses, said branch causing execution from the program memory to begin.

11. The system of claim 8, further adapted to perform a branch, said branch occurring in response to a first return program instruction, wherein execution from the program memory begins in response to said first return instruction in combination with a return address value in the program memory address range.

12. The system of claim 8, further adapted to perform a branch, said branch occurring in response to a second return program instruction, wherein execution from the expansion interface begins in response to said second return instruction in combination with a return address value in the expansion address range.
